(19) United States
(12) Patent Application Publication
(10) Pub. No.: US 2004/0194057 A1
(43) Pub. Date: Sep. 30, 2004

(54) System and method for constructing and validating object oriented XML expressions

(76) Inventors: Wolfram Schulte, Bellevue, WA (US); Barend H. Venter, Issaquah, WA (US); Chia-Hsun Chen, Redmond, WA (US); Erik Meijer, Mercer Island, WA (US); Christopher J. Lovett, Woodinville, WA (US); Matthew J. Warren, Redmond, WA (US)

Correspondence Address: Himanshu S. Amin, Amin & Turocy, LLP, National City Center, 1900 E. 9th Street, 24th Floor, Cleveland, OH, 44114, US

(21) Appl. No.: 10/396,651

(22) Filed: Mar. 25, 2003

(51) Int. Cl. G06F 9/44; G06F 7/00; G06F 17/30

(52) U.S. Cl. 717/114; 707/1; 715/513

(57) ABSTRACT

A system and method for enriching object oriented programming languages by employing XML literals, embedded expressions, and a flexible validator is provided. Object instantiation is accomplished by employing XML literals with optional embedded expressions. The XML literals themselves provide a means for concise programmatic denotation, which facilitates coding and debugging of XML data. XML embedded expressions, inter alia, allow complex objects to be constructed dynamically. The validation system and method provides flexible validation for the XML literals and embedded expressions using inference rules to describe when a literal expression is valid and what the resulting witness or proof is for the value denoted by the literal.

### TECHNICAL FIELD

The present invention relates generally to computer systems, and more particularly to object literal construction and validation in an object-oriented programming language.

### BACKGROUND

The future of c-commerce is largely dependant on development of what are referred to as Web Services, which are Internet based programmatic interfaces that provide valuable functions or services for users. For example, Microsoft Passport® is a Web Service that facilitates user interaction by transferring user profile information to designated websites. The broad idea behind Web Services is to loosely couple heterogeneous computer infrastructures together to facilitate data transmission and computation to provide the user with a simple yet powerful experience.

A significant component in functionality of Web Services is programmatic interaction with web data. However, the world of web data is presently quite disjunctive. In general, there are three major components that make up the world of web data—relational data (e.g., SQL), self-describing data (e.g., XML), and a runtime environment. FIG. 1 is Venn diagram 100 depicting a conventional web data world. A popular method of implementing a relational data model is by means of SQL (Structured Query Language). SQL is a language used to communicate with a relational database management system such as SQL Server, Oracle or Access—data in a relational database system is typically stored in tables. An accepted standard for self-describing data is XML (eXtensible Markup Language). XML is a World Wide Web Consortium (W3C) standard language that describes data via a schema or Document Type Definition (DTD). XML data is stored through the use of tags. A runtime environment is a general-purpose multilanguage execution engine (e.g., Common Language Runtime (CLR)) that allows authors to write programs that use both relational data and self-describing data.

However, there is an impedance mismatch between looseness of the “document world” from which XML evolved, and a more structured world of object oriented programming languages, which dominate the applications world. Bridging these two worlds today is conventionally accomplished by employing specialized objects that model the XML world called “XML Document Object Model,” or by “XML Serialization” technologies, which intelligently map one world into the other at runtime. However, these bridging mechanisms are often cumbersome and/or limited in functionality.

Object-oriented languages like C++, Java, and C# provide a way of defining classes and/or structs and then constructing instances of those types via “constructors” using the “new” operator. The objects being constructed and the arguments being passed to the constructors are all strongly typed. These languages usually also provide convenience mechanisms for initializing simply homogeneous arrays of objects. These constructs are designed to make programs written in these languages run fast.

XML, on the other hand, provides syntax for describing heterogeneous graph(s) of data where typing rules (usually called “schema validation”) are entirely optional and loosely bound to those type instances. Furthermore, the XML schemas associated with those documents can describe more complex structures with sequences, choices, unbounded type collections, and a combination of typed and untyped data using constructs like <xsd:any/> and <xsd:anyAtrribute/>. These constructs are designed to allow a loosely coupled architecture that minimizes hard dependencies between different parties that make up a complex distributed system and have proven to be the only way to make distributed systems scale up to a level of complexity required for today's interconnected business systems.

An additional problem with most conventional programming languages is that they do not provide literals for compound and/or user-defined types, and the few languages that do provide for literals are usually limited to certain built-in container types such as lists, sequences, arrays, and hashes.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention enriches object-oriented languages by providing XML literal expressions for building a combination of strongly typed objects and untyped XML. Therefore, the present invention facilitates a proper balance between looseness of XML and strongly typed programming models, and facilitates production of safe high performance XML oriented applications.

XML literals are provided in accordance with the subject invention to instantiate objects based on a class. The flexibility of XML literals allows construction of standard, user-defined and even compound objects. In addition, XML literal syntax provides an extremely clear and concise manner in which to construct objects—this allows programmers to be more productive in both writing code and debugging programs (e.g., especially with respect to programs that operate on XML data). Additionally, it is particularly effective to use XML literal syntax of the present invention for user-defined types since a large part of programming task(s) is in constructing and manipulating large object graphs. Furthermore, XML literals are strongly typed. Thus, errors can be generated early during program compilation where they can be fixed by professionals, rather than later during execution by a customer.

XML literals can also contain embedded expressions. As the name suggests, embedded expressions reside inside an XML literal and can be denoted by using a particular set of delimiters (e.g., curly brackets). Embedding expressions within XML literals allows dynamic literal creation and provides flexibility for coding professionals. In addition, embedded expressions greatly increase ability to generate complex object instances from classes and/or structs.

An XML expression validation system and method are also provided herein. A validation process in accordance with one particular aspect of the invention includes normalizing expressions and applying inferential rules to produce witnesses or proofs, which serve to validate individual expressions. The rules are defined in such a manner so as to allow for flexible validation, even allowing ambiguous content models, as long as the overall validation process is coherent. The validation rules also provide special string conversions that apply only during the validation process for added flexibility.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

FIG. 1 is a Venn diagram illustrating the intersection of conventional technologies.

FIG. 2 is a Venn diagram illustrating a suitable means of bridging technology gaps in accordance with an aspect of the present invention.

FIG. 3 illustrates an object literal creation system in accordance with an aspect of the present invention.

FIG. 4 illustrates an object graph in accordance with an aspect of the present invention.

FIG. 5 illustrates a subset of XML types in accordance with an aspect of the present invention.

FIG. 5a depicts an object graph with untyped subtrees in accordance with an aspect of the present invention.

FIG. 5b illustrates a collection of XML objects in accordance with an aspect of the present invention.

FIG. 6 is an exemplary node model illustrating mixed content in accordance with an aspect of the present invention.

FIG. 7 is an exemplary object graph in accordance with an aspect of the present invention.

FIG. 8 is a flow diagram illustrating the validation process in accordance with an aspect of the present invention.

FIG. 9 is a flow diagram illustrating the normalization of expressions in accordance with an aspect of the present invention.

FIG. 10 is a flow diagram depicting a validation rule in accordance with an aspect of the present invention.

FIG. 11 is a flow diagram depicting a validation rule in accordance with an aspect of the present invention.

FIG. 12 is a flow diagram depicting the process of performing string to type coercion on a string typed embedded expression in accordance with an aspect of the present invention.

FIG. 13 is a schematic block diagram illustrating a suitable operating environment in accordance with an aspect of the present invention.

FIG. 14 is a schematic block diagram of a sample-computing environment with which the present invention can interact.

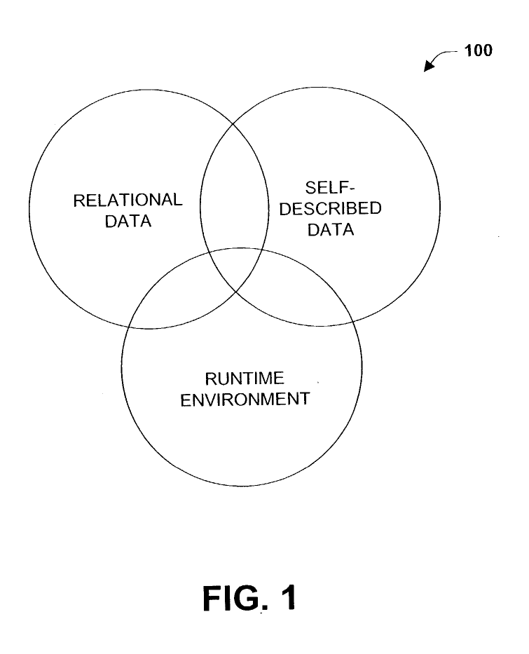

### DETAILED DESCRIPTION

The present invention is now described with reference to the annexed drawings, wherein like numerals refer to like elements throughout. It should be understood, however, that the drawings and detailed description thereto are not intended to limit the invention to the particular form disclosed. Rather, the intention is to cover all modifications, equivalents, and alternatives falling within the spirit and scope of the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

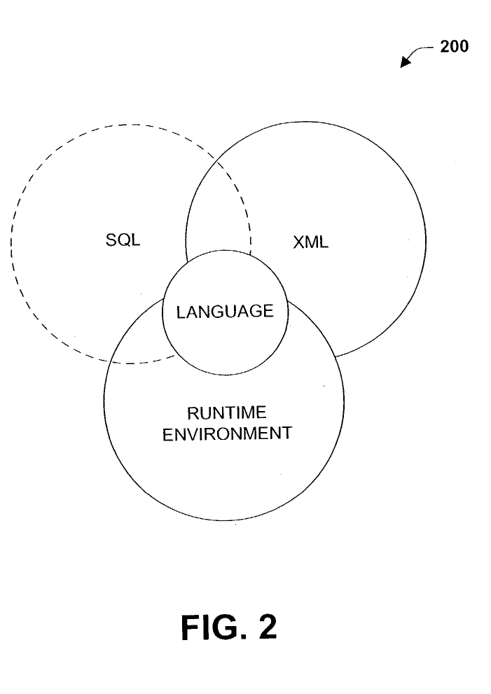

Turning initially to FIG. 2, a Venn diagram 200 is illustrated depicting a technique for bridging intersections between SQL, XML, and a runtime environment using a programming language. This invention, in particular, focuses on an interaction between XML and the runtime environment. XML data is self-described via attached identifying symbols or tags. A runtime environment, inter alia, compiles high level programming languages into machine instructions that can subsequently be executed by a processor. The present invention proposes a language solution to bridge technological gaps rather than utilizing APIs (Application Programming Interfaces), like conventional systems and/or methods. The language solution integrates the worlds of relational data (e.g., SQL), self-described data (e.g., XML), and a runtime environment (e.g., CLR or JVM) to present a coherent and unified interface to all three worlds. The amalgamation of worlds is accomplished by delving deeper than APIs and building a unified extended type system. Thus, the present invention facilitates incorporating some of the best features of many present day languages into a single cohesive language.

There are several unique aspects of object-oriented program language described supra, including the type system itself, novel compiler innovations, powerful relational and XML queries, and much more. The present invention enhances object-oriented programming languages by providing XML literal expressions, embedded expressions, and flexible validation thereof. Accordingly, programmers can write concise code and can be more productive in both writing and debugging programs, especially with respect to programs that manipulate XML data.

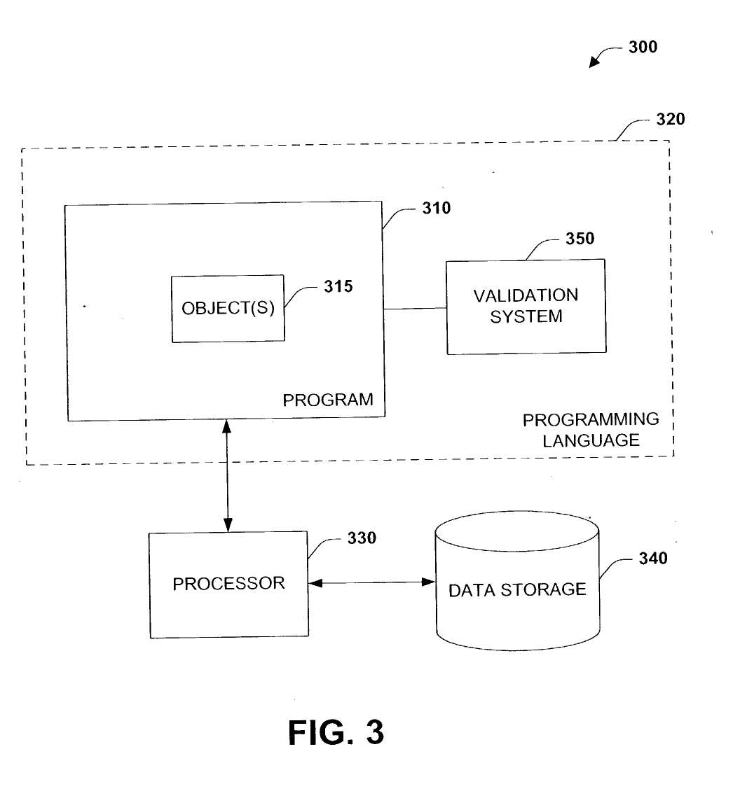

Turning to FIG. 3, a system 300 for creating programmatic object instances is illustrated in accordance with an aspect of the present invention. A program 310 is created by employing functional constructs provided by a programming language 320, wherein the programming language 320 is a strongly typed object-oriented language. The program 310, more specifically, includes instructions for constructing object(s) 315. The object(s) 315 are programmatically employable data structures that represent real or abstract items or entities. The object(s) 315 generally comprise a bundle of variables and related methods that represent both a state and a behavior of the object(s). An object's state and behavior are capable of being manipulated, after instantiation, by invoking procedures on the object, which alter its variables. The structure and function of an object or objects is defined by its related class. The present invention employs XML expressions to construct or instantiate object(s) 315 in accordance with their class definition, for instance by employing validator 350 to create object creation expressions. The object(s) 315 can be checked for errors at compile time by validation system (validator) 350. The program 310 can be produced by means of a strongly typed programming language to increase ability to detect errors prior to execution. After the program 310 and its object(s) 315 are compiled and validated by the validator 350, the programs instructions are run or executed on a processor 330. The processor 330 interacts with a data storage 340 (e.g., caching, retrieving instructions, etc.) to execute at least the program 310. Furthermore, the program 310 can employ the data storage 340 to allocate memory for instantiated object(s) 315.

XML expressions (also referred to as XML literals or XML literal expressions) are a different kind of primary expression, which is similar, yet markedly distinct, from a standard object-creation expression. In brief, expressions construct objects using one or more XML literals and a defined class structure declared within or otherwise tied or imported into a program code. For example:

Class Person {

public string Name;
public string Height;
public string Email;

| } | |
|---|---|
| Person person = | <Person> |

<Name>Bill Smith</Name>
<Height>186</Height>
<Email>bsmith@xyzcorp.com</Email>

</Person>;

In the above code snippet, a class Person is first declared. The Person class simply discloses that a Person object will include three public string members: Name, Height, and Email. The object person is then instantiated based on the Person class. Notice that the object person is defined using XML expressions. The XML expression is substantially equivalent to the following conventional method of instantiating and defining an object, except that the XML expression allows developers to be much more productive in writing and debugging programs, especially those that build large object graphs and interact with other systems via streams of XML data.

Person person = new Person( );
person.Name = “Bill Smith”
person.Height = 186;
person.Email = “bsmith@xyzcorp.com”

According to an aspect of the present invention, any well formed XML markup is permissible in an XML literal expression, including double and single quoted attributes, XML comments, processing instructions, and CDATA sections. For example:

| | |
|---|---|
| Author author = | <Author id = “123” publisher = ‘Wrox’> |

<!--This author publishes articles online-->
<First>Bill</First>
<Last><!CDATA[this is CDATA text here]]></
Last>

</Author>;

Here a tag <Author> has two attributes, id and publisher, with declared values “123” “Wrox,” respectively. Additionally, a comment “This author publishes articles online” is incorporated between the author tags. Furthermore, character data (CDATA) “this is CDATA text here” is also illustrated as part of the XML expression. It is to be appreciated by those of skill in the art that a sequence of characters and elements in a literal expression are limited only by the capabilities of the underlying language type system, and any specific rule or set of rules described herein is meant to be illustrative of the capabilities of the present invention and not meant in any way to limit the scope of the invention.

It should also be noted and appreciated, that XML expressions can be strongly typed. Therefore, type check errors can be generated early on during program compilation where they can be fixed, rather than later during execution by a customer. For instance, in the above author object, if author did not have an id attribute, or if the value “123” could not be coerced to the type of the id attribute, etc., an error could be generated and the program would not compile, therefore protecting against the possibility of errors resulting in the generation of XML data that does not conform to the desired schema.

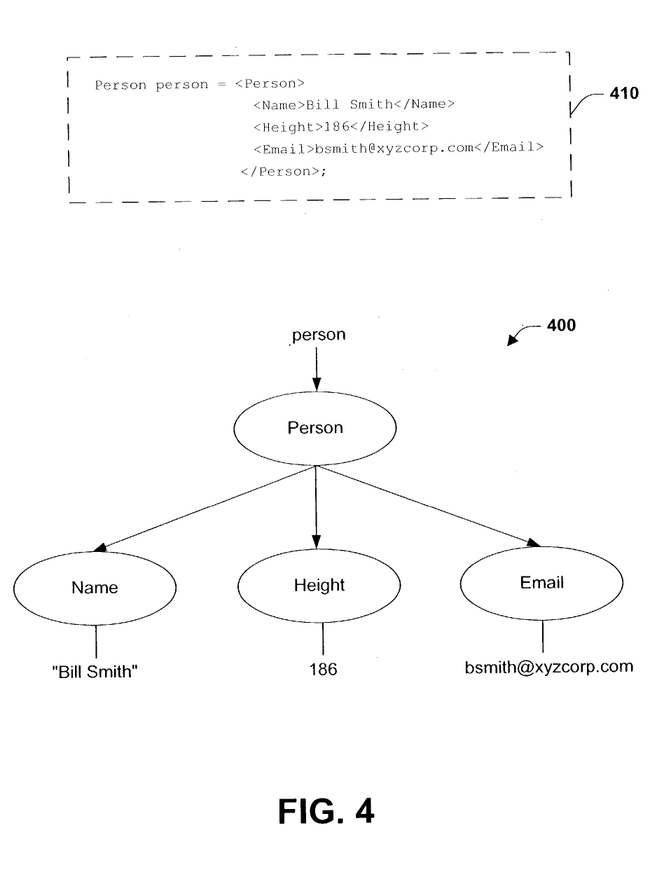

Furthermore, constructing objects using XML expressions facilitates construction of object graphs. Turning to FIG. 4, an object graph 400 is depicted. Object graphs such as structured object graph 400 depict a relation of objects and are useful in validating object data, data manipulation, and data querying. Heterogeneous object graphs are constructed by employing tagged data of XML expressions. It is the tags themselves that give structure to otherwise structure-less data. The object graph 400 corresponds to an XML expression defining an object person. Code is displayed above the object graph 400 for ease of understanding. Object graph 400 illustrates four nodes: Person 410, Name 420, Height 430, and Email 440. Each of the nodes corresponds to an element as specified by expression 405. Expression 405 defines an object Person. The object Person, according to the expression 405, includes an element <Person> and sub-elements <Name>, <Height>, and <Email>. Person 410 corresponds to the element <Person>, while Name 420, Height 430, and Email 440, correspond respectively to elements <Name>, <Height>, and <Email>. Values of each element are shown attached below to their respective elements. Note that the validation process converts what looks like untyped XML data into typed values. For instance, the Height of 186 that looks like text in the XML expression is mapped to the public Height member, which is strongly typed as an integer. XML Expressions arc therefore “strongly typed.” Additionally, it should be noted that constructed objects could employ XML Expressions that contain or include both typed and untyped elements. In such a case, a semi-structured or partially-typed object graph can be produced to depict object relationships. Finally, it should be appreciated by those of skill in the art that object graphs both structured and semi-structured are simply one method of visually representing how an object is stored in memory.

XML expressions may also contain embedded expressions. One technique of delimiting an embedded portion of the expression is via curly brackets, “{” and “}”. These brackets or any other characters or set of characters may be employed to mark a beginning and ending of an embedded expression. The following is a simple example:

String a=“Aaron Johnson; Martin Moore”;

Author author=<Author>{a}</Author>;

The embedded expression {a} can expand value “a” inside a construction of an <Author> tag. XML literals with embedded expressions are extremely versatile, for example, a programmer could employ embedded expressions to compute a value of an attribute, by using curly brackets instead of quotes around the attribute value, as follows:

String a=“Peter”;

Author author=<Author name={a}>;

Embedded expressions could also be employed for computational purposes. For instance:

Person p=<Person age={x+y+Math.Abs(z)}/>

In fact, embedded expressions may contain a list of statements followed by an expression.

The actual type of the embedded expression below is the type of a final expression in the list. For example:

| | |
|---|---|
| Person p = | <Person> |

<First>{

//statement list.
StringBuilder b = new StringBuilder( );
Random r = new Random( );
for (int i = 0; i < 10; i++) {

b.Append(Convert.ToChar(r.Next(0x61,
0x7A)));

}
b.ToString( );// expression typed as string.

}</First>

</Person>;

Furthermore, since embedded expressions can contain any language expression they can also contain nested XML literal expressions. For example:

| | |
|---|---|
| Book book = | <Book> |

<Author>
{

<Person>

<First>Bill</First>
<Last>Smith</Last>

</Person>

}
</Author>
<Title>The Power of XML Expressions</Title>

</Book>;

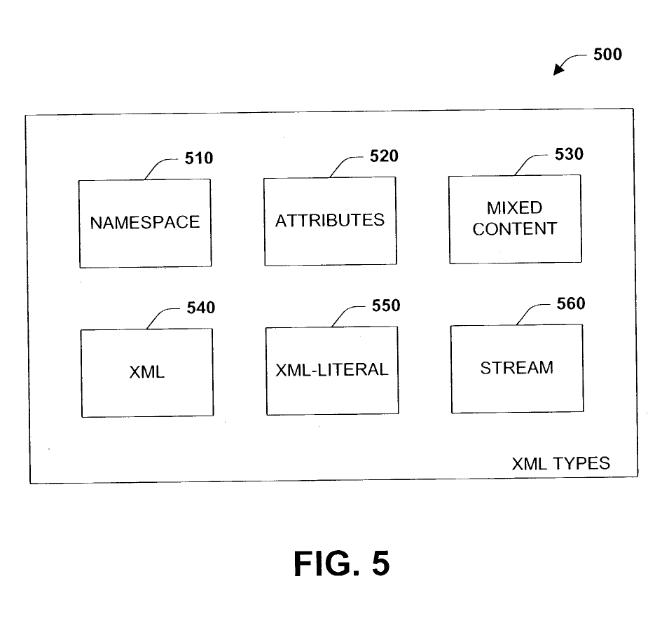

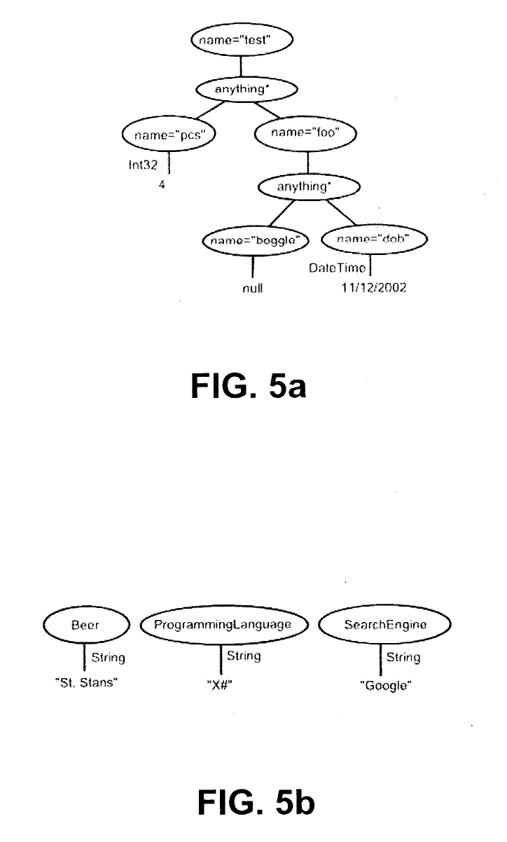

Additional benefits of XML expressions, including flexible yet concise object declaration, that can be realized based at least upon an underlying XML type system. Referring to FIG. 5, a subset of XML types 500 supported by a programming language of the present invention that can be utilized with XML literals and embedded expressions is illustrated. XML types 500, include namespace 510, attributes 520, mixed content 530, xml 540, xml-literal 550, and stream 560.

One aspect of the present invention focuses on an interaction between an object-oriented programming language 320 (FIG. 3) and XML data. XML data is stored in XML documents. XML schema definitions (XSD) or XML schema define grammar for XML documents. Stated differently, the grammar specifies rules for which an XML document must adhere in order to be validated and be considered well-formed. To support interaction between a programming language and XML data without employing application programming interfaces (APIs), portions of the XML schema definition have been mapped into the language 320. However, the format of some elements of the XSD has been modified to support strong typing in the object-oriented language 320.

One aspect of the present invention includes mapping XML schema namespaces 510 into the language 320. Namespaces 510 help to prevent confusion and assist in the validation process. As mentioned previously, XML documents are loosely formed. For example, XYZ corporation may use a substantially similar vocabulary to refer to distinctly different items. For example, assume the XYZ corporation stores data about its operations in an XML document. Further assume that the XML document uses a tag <name> to refer to both employee names and vendor names. This is problematic when it comes to programmatically referencing either employees or vendors. To avoid such confusion, namespaces are declared. Namespaces include a prefix and a unique identifier such as uniform resource identifier (URI) or uniform resource name (URN) (e.g., http://www.xyzcorp.com/employees). Conventional XML practice is to prepend a type prefix to the tag name (e.g., <emp:name>) to allow the tag to be uniquely identified. The present invention, however, makes it easier to associate a URI with a class and facilitates strong typing, by providing an extended namespace-declaration that allows a quoted literal containing a namespace URI. The grammatical structure is:

namespace-declaration:

namespace qualified-identifier namespace-body ;optional

namespace string-literal namespace-body;

where the string literal is a valid URI or URN. The namespace URI or URN is then associated with all types defined in the namespace body. This form of namespace declaration extends the conventional form.

Furthermore, in accordance with an aspect of the present invention, both the new form and the conventional form of the namespace-declaration can be nested inside the other. For example:

namespace http://schemas.xyzcorp.com/purchasing {

namespace Asia {

Class Supplier {
}

}
namespace “/shipping” {

Class Address {
}

}

}

As a convention, the concept of a “namespace URI qualified type” is denoted by abstract syntax: {NamespaceUri}identifier. Thus, the above declaration results in the following fully qualified types being defined:

{http://schemas.xyzcorp.com/purchasing}Asia.Supplier, and

{http://schemas.xyzcorp.com/shipping}Address.

In addition, since there is no fully qualified identifier for types that have associated namespace URI's, a using-directive can be employed to reference them. The present invention extends the using-namespace-directive to allow quoted literals containing namespace URI's as follows:

using-namespace-directive:

using namespace name;

using string-literal;

The string-literal in this case is a valid URI. This allows all types associated with the namespace URI to be imported into the current scope so that they can be referenced without qualification.

Another aspect of the present invention includes the extension of the using-alias-directive with a namespace URI form. For example:

using-alias-directive:

using identifier namespace-or-type-name;

using prefix=string-literal;

In this case, the namespace URI should be a non-empty absolute URI. The prefix can then be used as a qualification, for example, with a dot (.)or a colon (:) as follows:

using x = “http://www.w3.org/200/svg” :
x.ellipse GetEllipse( ) {

return <x:ellipse cx=50 cy=50 rx=100 ry =50/>;

}

Note, with respect to the XML literal above (shown using the colon), that the using directive is taking the place of an “xmlns” namespace declaration. It should be appreciated by those of ordinary skill in the art that XML literals can also employ a standard “xmlns” attribute for declaring prefix/namespace URI mappings which can override the using directives. More details on namespaces in XML literals are discussed infra.

Furthermore, by mapping the namespace 510 into language 320, language 320 implicitly knows of the XSD (XML Schema Definition). Functionally, it is as if all programs written in language 320 contain the statement:

using @xml=“http://www.w3.org/XML/1998/namespace”;

Thus, standard attribute types such as “xml:space,” “xml:lang,” and “xml base” can be defined.

Language 320 also contains attribute type 520. The attribute type 520 supports XML attributes in a first class manner by using an attribute keyword with support for default and fixed values, and required attributes. It is important to incorporate support for attributes into language 320 in order to accurately represent XML data.

The simple default mapping of <xsd:attribute> is to a field which is marked with the attribute keyword. The following is an example of this kind of mapping:

<xs:complexType name=“rect”>

<xs:complexContent mixed=“false”>

<xs:extension base=“tns:shape”>

<xs:attribute name=“x” type=“xs:integer” />
<xs:attribute name=“y” type=“xs:integer” />
<xs:attribute name=“width” type=“xs:integer” />
<xs:attribute name=“height” type=“xs:integer” />

</xs:extension>

</xs:complexContent>

</xs:complexType>
→public class rect : shape {

attribute int x;
attribute int y;
attribute int width;
attribute int height;

}

The XML <xsd:attribute> also defines additional metadata about attributes which are also mapped to the language 320 via attribute type 520 as follows. The default value of an attribute in XSD is mapped to a field initializer. For example, from HTML:

<xs:attribute default=“Jscript” name=“language” type=“xs:string”/>

→attribute string language=“Jscript”;

A fixed value of an attribute in XSD may be mapped to a read only attribute. For example from SVG (Scalable Vector Graphics):

<xs:attribute fixed=“1.0” name “version” type=“xs:string”/>

→readonly attribute string version“1.0”;

In this case a compiler will disallow any other value for this attribute other than “1.0” which is the intention of “fixed” in XSD. The use attribute in XSD can have values optional, prohibited, and required. Required is mapped to type modifier !. The lack of this type modifier means that the attribute is optional in XML literals. For example, from SVG:

<xs:attribute name=“points” type “xs:string” use=“required”/>

→attribute string! points;

The optional attributes have no explicit default value and may be initialized with a default value assigned by the runtime during normal object construction. For numeric types this is usually the value zero. The XSD attribute use=“prohibited” is a method for removing an attribute that was inherited from a base type. In other words, it provides a simple form of derivation by restriction. One method the present invention employs to facilitate this functionality is to override an inherited attribute using a “new” keyword and providing a read only null value for the attribute. For instance:

Class MyClass : BaseClass {

new read only attribute string whatever = null;

}

This will make it illegal to specify any value other than null in XML literals, which is the XSD intention of use=“prohibited.”

Also included in attributes 520 is support for special attributes. Some of the special attributes include those with an “xml” prefix, like xml:space, xml:lang, and xml: base. xml:space is an attribute that allows one to declare a significance of white space (e.g., preserver or not). An exemplary language construct can be the following:

attribute System.Xml.XmlSpace xml:space;

This attribute can then be populated with corresponding attribute values from compiled XML literals or from XML serialization. In this example, a value of the attribute should be either “default” or “preserve” to avoid a compile error.

The xml:lang attribute allows XML authors to specify a particular language used within an element (e.g., English, German, French, Latin, etc.). The language attribute may be mapped to the following language construct in the present invention:

attribute string xml:lang;

This attribute can also be populated with corresponding attribute values from compiled XML literals or from XML serialization. However, in accordance with an aspect of the present invention, the attribute has no special meaning to the compiler, therefore, the values do not need to be checked by a compiler for validity.

The xml:base attribute allows XML authors to specify a base URI for a document other than base URI of the document. The xml:base attribute maybe mapped to the following language construct:

Attribute string xml:base;

This attribute is similar to the xml: lang attribute in that the xml: base attribute can be populated with corresponding attribute values from compiled XML literals or from XML serialization. Except, in accordance with an aspect of the present invention, the attribute has no special meaning to the compiler, therefore, the values do not need to be checked by the compiler for validity.

Finally, attributes 520 may provide support for dynamic properties. Many important XML schemas, like XHML (eXtensible Hypertext Markup Language), SVG (Scalable Vector Graphics), SMIL (Synchronized Multimedia Integration Language) and MathML (Mathematical Markup Language) use attribute inheritance, also known as Cascading Style Sheets (CSS), where attribute values, like background color, that are not specified on a given node, inherit the value from their parent nodes or from a stylesheet specified by a class attribute. Dynamic properties also imply an ability of a given node in a tree to get notifications when the value of the inherited property changes. This approach is a particularly efficient for storage optimization because typically there are a plurality of possible properties, but only a small number are defined on any given node at a given time.

Another XML type 500 supported by the language of the present invention includes mixed content 530. Mixed content type elements include text, elements, and attributes. Mixed content is specified as a complexType in XSD. In general, mixed content means that an clement can include text anywhere between its child elements. Mixed semantics applies to all content particles in the complex type, but there is no inheritance down the tree to the content model for child elements.

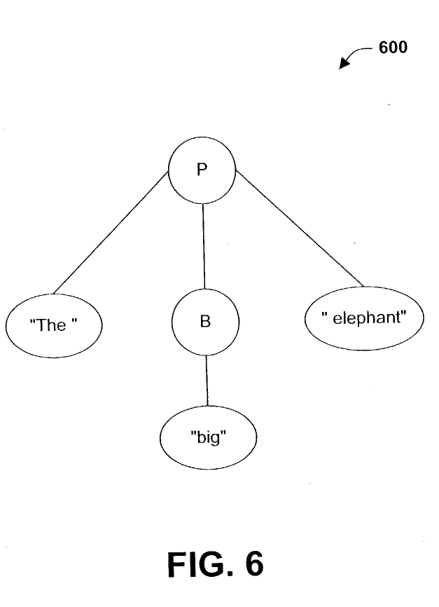

Turning briefly to FIG. 6, a node model 600 illustrating a mixed type is depicted. Node model 600 corresponds to the following mixed expression: <p>The <b>big</b>elephant</p>. Notice that <p> element contains both text and elements. More specifically, the <p> element contains text and one child element <b>.

Full support for mixed content can be accomplished by employing a mixed keyword on a class, struct, or interface as follows:

mixed class Part
{

sequence {

Foo foo;
Bar bar;

};

}

This denotes that a paragraph includes zero or more underline, bold, or italic tags with any amount of intervening text. The following is a valid instance of the class:

para p=<para>The <b>big</b>elephant</para>;

Furthermore, an embedded expression can also be used to construct this literal. For instance:

para p=<para>{GetPara( )}</para>;

To allow the above expression to work without error, an author would have to type a return value with a mixed keyword. Additionally, the type system 500 of the present invention incorporates special XML literal syntax for <xsd:any> content, namely untyped <xml>, described further infra. Thus, a GetPara( ) function could look something like this:

(bold|italic|string)* GetPara( ) {
Return <xml>The <bold>big</bold> elephant</xml>;
}

Notice that a side effect of using untyped <xml> element is that its child elements must all be types, hence <bold> is written rather than <b>.

XML white space is a special kind of mixed content that is significant when appearing inside an XML element marked with the special attribute xml:space=“preserved”. Unlike mixed content, white space preservation is inherited down the tree so that a child has to preserve white space if it is in the scope of a parent element that has xml: space=“preserve”. Furthermore, a child can turn preservation off, so that its children can inherit non-white space preservation behavior. For example:

<p xml:space=“preserve”>

<i>The</i><b>big</b><font size=“5”>E</font><i>elephant.</i></p>

Which is would be presented in a browser as follows:

The big Elephant.

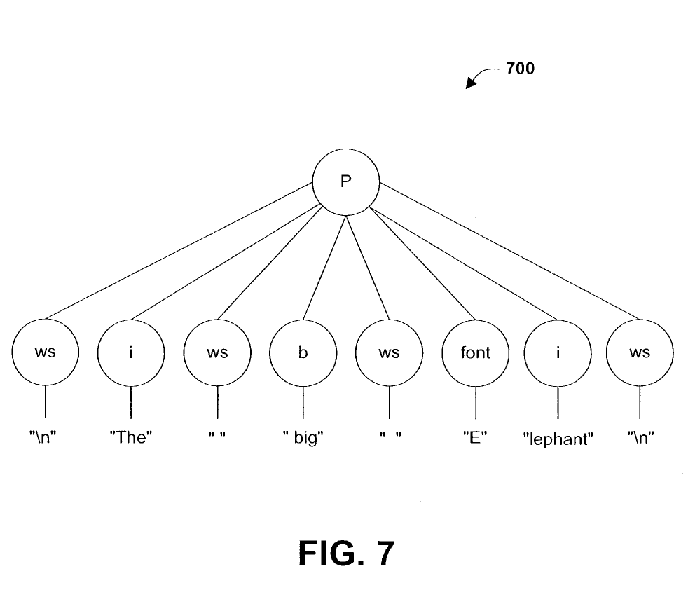

From an XML point of view, <p> element contains four child elements <i>, <b>, <font>, and <i>; however, there happens to be space between some of the children. If a parser drops these spaces, a meaning of the content gets mangled. In other words, word boundaries are lost. Conversely, a lack of white space between </font> and <i> tags is important to maintain. Turning briefly to FIG. 7, an object graph 700 illustrating the above expression is shown. As illustrated the <p> element contains more than just text and elements. It contains string objects containing just white space (ws).

Turning back to FIG. 5, an additional type supported by the language of the present invention is the “xml” type 540. The xml type 540 allows programmers to write untyped XML literals. For example:

```
xml stuff = <xml>
          <SomeRandomElement whatever=“123”/>
          <!-- want to coment? -->
          How about more text content?
          <?pi anyone?>
          </xml>
```

In addition, the xml type can also be used in an embedded expression, so long as the expected type is untyped XML. Furthermore, the xml type can be queried using full language query expressions.

Support is also provided for an xml-literal type 550. An xml-literal 550 is any sequence of characters surrounded by tags (e.g., <Author>Aaron Johnson</Author>). By providing support for xml-literals 550, the present invention allows such representations to be employed in expressions arrays, lists, streams, etc., without first having to construct a literal (e.g., utilizing a new operator). For instance, an array can be initialized simply by using xml-literals as follows:

Author[] a = { <Author>Aaron Johnson</Author>,
<Author>Martin Moore</Author> };

In XSD schemas there is a special element called <xsd: any>, which is used whenever an untyped subtree is desired in an XML document. For example, the following schema defines an element named “Profile” which is allowed to contain any child element content:

```
<xsd:complexType name=“User”>
  <xsd:sequence>
    <xsd:element name=“PUID” type=“xsd:string”/>
    <xsd:element name=“FirstName” type=“xsd:string”/>
    <xsd:element name=“LastName” type=“xsd:string”/>
    <xsd:element name=“Email” type=“xsd:string”/>
    <xsd:element name=“Profile”>
      <xsd:complexType>
        <xsd:sequence minOccurs=“0” maxOccurs=“unbounded”>
            <xsd:any/>
        </xsd:sequence>
      </xsd:complexType>
    </xsd:element>
  </xsd:sequence>
</xsd:complexType>
```

<xsd:any> has some different options in XSD. Specifically, an author can specify which namespaces the elements are allowed to come from as follows:

##any Any element from any namespace is allowed

##other Any element from namespace except the target namespace is

##target-namespace Any element from the target namespace is allowed

##local Any element with no namespace is allowed

namespace URI Any element from the given namespace is allowed

Additionally, it should be appreciated that various combinations of the above may also be specified.

In addition, there is a processContents attribute that defines the validation behavior for these elements, with the possible values:

lax Validate elements that are recognized and allow elements that are not

skip Do not validate any elements

strict All elements in the any block must be validated.

According to an aspect of the present invention, an untyped subtree and associated process attributes can be specified using the xml type. For instance, strict validation is for heterogeneous collections of strongly typed objects. Therefore, if the schema for the Profile element of the User complexType illustrated supra, was defined using <xsd: any processContents “strict”> the “Profile” element declaration is mapped to a semi-structured object oriented type as follows:

```
class User {
    public string PUID;
    public string FirstName;
    public string LastName;
    public string Email;
    [XmlAnyElement (processContents=“strict”)]
    public object* Profile;
}
```

where object* is a stream type, containing zero or more objects. A valid literal for this class would be as follows:

```
User user = <User>
              <PUID>A647162</PUID>
              <FirstName>Chris</FirstName>
              <LastName>Lovett</LastName>
              <Email>chris.lovett@someplace.com</Email>
              <Profile>
                <Beer>St. Stans</Beer>
                <ProgrammingLanguage>X#</ProgrammingLanguage>
                <SearchEngine>Google</SearchEngine>
              </Profile>
            </User>;
```

When processContents attribute is set to “lax” it allows a combination of typed and untyped elements as children of the <xsd: any> element. For example, if the Profile element was defined with processContents=“lax” then the Profile field would be mapped to the following loosely typed member:

[XmlAnyElement (processContents=“lax”)]
public xml Profile;

Subsequently, the xml type can be utilized and one can specify processContents=“lax” in the XmlAnyElement attribute. The following literal for the User class could be written:

```
User user = <User>
              <PUID>A647162</PUID>
              <FirstName>Chris</FirstName>
              <LastName>Lovett</LastName>
              <Email>clovett</Email>
              <Profile>
                <test>
                  <pcs>4</pcs>
                  <foo>
                    <boggle/>
                    <dob>1966-02-01</dob>
                  </foo>
                </test>
              </Profile>
            </User>;
```

Now assuming that the <pcs> and <dob> elements are resolved to the following types:

typedef pcs=int;

typedef start=DateTime;

And, further assuming the <test>, <foo> and <boggle> elements are not resolvable, then the contents of the Profile field contains the object graph depicted in FIG. 5a.

Furthermore, the xml type can be employed with the processContents=“skip” attribute. This attribute is utilized for untyped sections of XML, and can be mapped similar to the processContents=“lax” attribute with a different custom attribute. For instance:

[XmlAnyElement (processContents=“skip”)]
public xml Profile;

It should be appreciated that implementing processContents=“lax” and processContents=“skip” in a consistent fashion facilitates implementation of other aspects of language 320 (e.g., queries). Further, when a programming language compiler sees processContents=“skip” it simply stops trying to resolve any element names to types and stores everything as untyped elements, attributes and string leaf values.

Turning briefly to FIG. 5b, a collection of XML objects is shown. The collection of objects corresponds to objects that would reside in the Profile field when the processContents attribute is set to “skip” given the exact same literal as shown above with respect to processContcnts=“strict”.

In order to map the meaning of the namespace attribute to language 320 one needs to figure out what the targetNamespace means in a program 310. One definition is to take the namespace of the enclosing scope, for example, the namespace of the class containing the field of type <xsd:any>. Then when constructing the field of type <xsd:any>, the language compiler could check the namespace for the objects in the literal against the current namespace and apply the rules as follows:

##any Allows objects from any namespace (the default).

##other Allows objects from any namespace other than the target namespace

##target- Allows objects from the target namespace only namespace

##local Only allows objects with no namespace (limited to the current assembly)

namespace URI Allows objects only from the specified namespaces.

These namespace options can be specified in language 320 using a custom attribute such as:

```
class User {
    public string Name;
    [XmlAnyElement (processContents=“lax”, namespaces=“##other”)]
    public [xml*] Profile;
}
```

In XSD anyAttribute is a wildcard that allows any number of other attributes to be included on an XML element. There is no such thing as anyOneAttribute in XSD. It is as if anyAttribute has an implicit maxOccurs=“unbounded”. This concept can be mapped to language 320 as follows:

class Foo {
attribute any;
}

It should be noted that “any” is a keyword, and thus we essentially have a special kind of field declaration here. Furthermore, attributes that do not map directly to an attribute field can be put inside a hashtable, which then provides efficient named lookup. For example:

Foo f=<Foo bar=“123”/>;

string value=foo.any[“bar”]; //returns the value=“123”.

Attributes can also be added, and changed in this collection dynamically as follows:

foo.any[“bar”]“123”; // add

foo.any[“bar”]“456”; // change

foo.any[“bar”]=null; // remove

Turning back to FIG. 5, the type system 500 also supports stream types 560. A stream is list of values. The main distinction between a stream type and a list is that streams utilize occurrence constraints. For instance:

T* denotes streams with >=0 elements of type T

T+denotes streams with >=1 elements of type T

T? denotes streams with=<1 elements of type T

T! denotes streams with==1 elements of type T

Thus, a stream can be empty, non-empty, finite, infinite, etc., depending what is desired and effectively denoted. Exemplary literal syntax for initializing stream types includes:

| | |
|---|---|
| Author* list = | <Author>Aaron Johnson</Author> |
| | <Author>Martin Moore</Author>; |

This defines the variable “list” as being of type “zero or more Authors”, and initializes this list with two authors, Aaron Johnson, and Martin Moore.

Turning back to FIG. 3, notice that the system 300 incorporates a validation system 350. Validation is what bridges worlds of documents and types. As mentioned supra, XML expressions are strongly typed. This means that element field values must match their declared value or an error will be produced. In the following example of the instantiation of object person, the <Name> element contains the value “Bill Smith” which is of type string, which is valid. However, the element <Height> contains the value “tall” which is not an integer as declared. Thus an error will be produced.

```
class Person {
    sequence {
        string Name;
        int Height;
    }
}
Person person = <Person>
                <Name>Bill Smith</Name>
                <Height>tall</Height>
            </Person>;
```

In accordance with an aspect of the present invention, a compiler of language 330 can also be a schema validator, which facilitates creation of correct content models at compile time rather than waiting for a run time error. Furthermore, the language 330 also supports strongly typed embedded expressions. The strongly typed nature of embedded expressions allows for loosening of some validation rules without introducing ambiguity (e.g., allowing tag names to be omitted in certain cases).

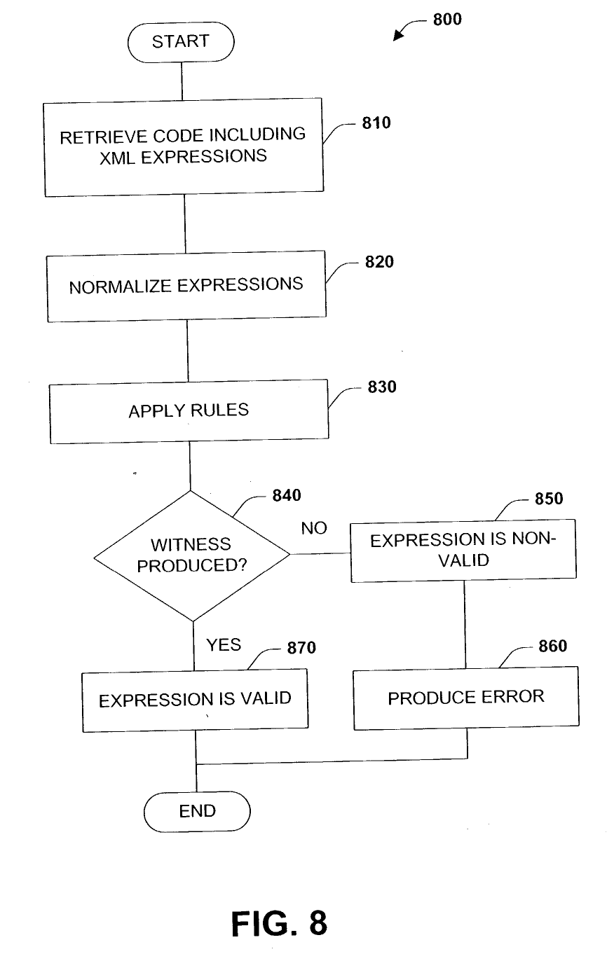

FIG. 8 is a flow diagram illustrating a process of validation 800. First, at 810, a written code to be validated and any XML expressions therein are retrieved. At 820, the XML expressions are normalized in preparation for application of validation rules at 830. At 840, a determination is made as to whether a witness was produced from the application of the rules. If a witness was not produced, the expression is declared non-valid at 850, an error is produced at 860, and the process terminates. If, however, a witness is produced, the expression is declared valid at 870 and the process terminates. In addition, it should be noted that if an expression can be validated in more than one way, the expression is said to be ambiguous. However, the validation rules allow this as long as all corresponding witness expressions denote a substantially similar value.

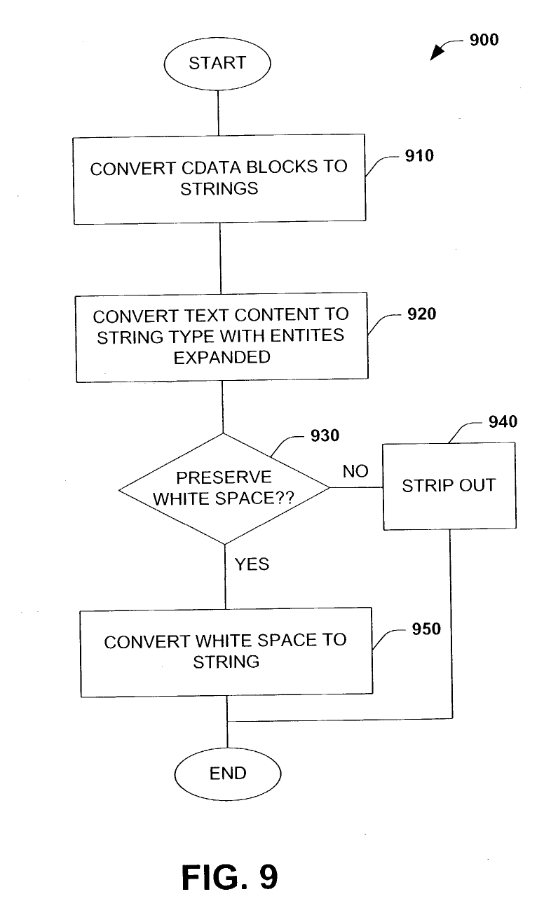

Turning to FIG. 9, a flow diagram depicts a normalization process 900 of an XML expression in accordance with an aspect of the present invention. Normalization process 900 is made to prepare the XML literal expressions for an application of validation rules by validation engine 350. At 910, any character data CDATA blocks are converted to strings. Next, text content is converted to a string with entities expanded, at 920. Then, at 930 a determination is made concerning whether white space is to be preserved or not. If the white space is not to be preserved, it is striped out at 940. Otherwise, the white space is converted to a string object at 950. Furthermore, it should be noted, as it is not shown, that the validation system 350 ignores all comments and processing instructions because they are orthogonal to the type system. After normalization, validation rules can be applied to the XML literal expressions.

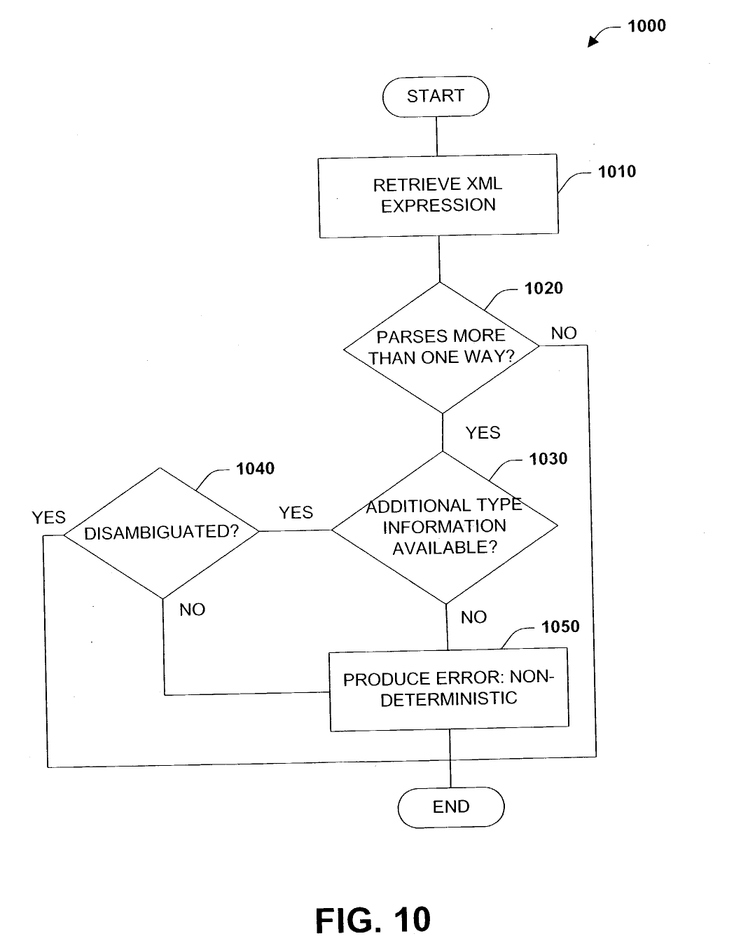

Referring to FIG. 10, a flow diagram 100 is illustrated depicting a validation rule in accordance with an aspect of the present invention. Unlike XML schema validation, where content models must be deterministic, a validator of the present invention loosens a deterministic rule such that a content model can be ambiguous as long as a specific XML literal expression parses deterministically. At 1010, a validation process begins by retrieving an XML expression. At 1020, a determination is made to determine whether the expression parses in more than one way. If no, the process terminates without error. If yes, at 1030, the programming code is looked at to determine if additional information is available to help disambiguate the expression. If there is no additional information that could help the validator then an error is produced at 1050, which declares the expression non-deterministic, and the process subsequently terminates. If, on the other hand, information is available, the validator determines whether the information disambiguates the XML expression at 1040. If yes, the process terminates without error. If no, the expression is declared non-deterministic and an error is produced at 1050.

Programmers often provide disambiguating information in the form of a class to help guide the validator. For instance, given the following class:

```
class a {
    choice {
        string B;
        int B;
    }
}
```

one would expect to be able to write the XML expression <A><B>{“4711”}</B></A> and <A><B>{4711}</B></A> and even<A><B xsi: type=“int”>4711</B></A>. However, <A><B>4711</B></A> would not validate with the given information since the validator cannot determine whether 4711 is an integer or a string.

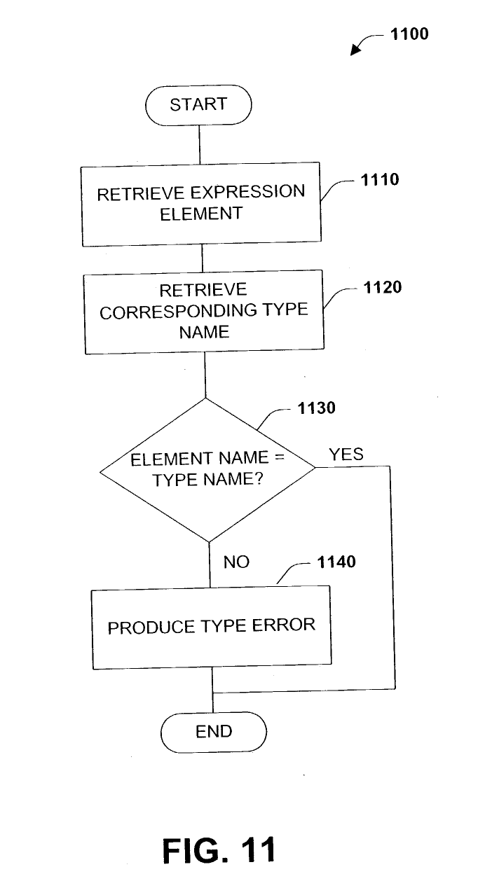

FIG. 11 depicts another validation rule or process 1100 in accordance with an aspect of the present invention. Process 1100, begins at 1110 where an XML expression element name is retrieved. At 1120, an XML type name is retrieved from a program code. A comparison is then made at 1130 between the type name and the element name. If the type name does not match the element name, then an error is produced at 1140 indicating a non-resolvable type has been encountered. Thus, an error would be produced for the expression Person person=<Emplpoyee/>, because the element name “Employee” does not match the type name “Person.”

Additionally, it should be appreciated that the described process can also be applied to child elements where there is no field label specified (e.g., int x=int>23</int>). However, if a field label is employed, the child elements should use the mapped name. For example, suppose the following classes:

```
class Circle {
    sequence {
        Point center;
    }
}
class Point {
    sequence {
        int x;
        int y;
    }
}
```

Using the above class definitions, the XML literal for constructing a Circle should use the field name “center” as follows:

Circle p <Circle><center><x>1</x><y>2</y></center></Circle>;

Validations of embedded expressions in an XML literal expression require special XML literal string coercions to facilitate ease of use. For purposes of clarity and ease of understanding the following code is provided:

```
class Engine {
    attribute float HorsePower;
    attribute float Capacity;
    attribute float PeakTorque;
    attribute float PeakTorqueRPM;
    }
string hp = “302”;
Engine e = <Engine HorsePower={hp}
Capacity=“5.0” PeakTorque=“339”
PeakTorqueRPM=“2700”/>;
```

Here, an embedded expression {hp} and other attributes are typed as string, but attribute members are all typed as float. In this case, validator will coerce the strings to floats.

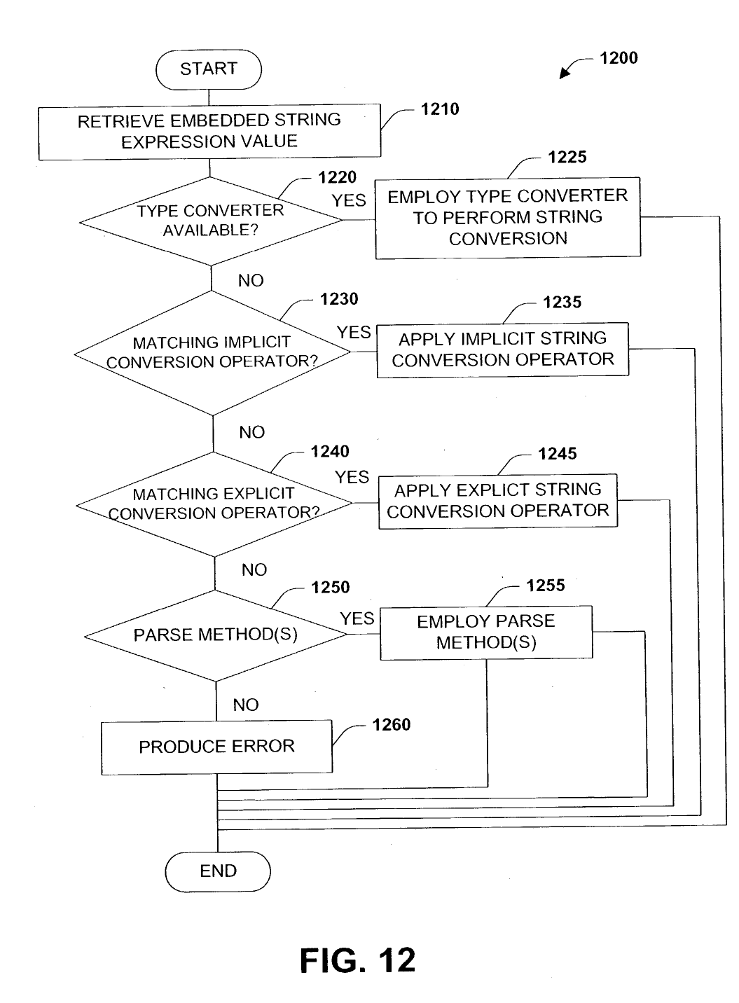

Turning to FIG. 12, a flow diagram depicts a process 1200 for performing string to type coercion on a string literal or a string typed embedded expression. The process 1200 allows an embedded expression to be assigned to a typed member. At 1210, a string expression value is retrieved. At 1220, a check is made to determine if an appropriate type converter is available. If yes, then the type converter is utilized to perform a string conversion at 1225. If an appropriate type converter is not available at 1220, a language validator looks for a matching implicit string coercion operator at 1230. For instance, public static implicit operator T(string s); where T is a type of a member being initialized. If a matching implicit string coercion operator is available then it is employed at 1235 to make an appropriate conversion. Otherwise the validator looks for an explicit string coercion operator at 1240. If the explicit string coercion operator is available, it is employed at 1245. Else, the validator looks for parse method(s) at 1250 to perform a string coercion at 1255. However, if a parse method is not available the validator will produce a coercion error at 1260.

Additionally a validation rule may coerce a type to a string. For example:

```
class Fruit {
    attribute string name;
    attribute string calories;
}
enum CommonFruits
    Apple, Banana, Mandarine, Nectarine, Orange, Peach, Pear
}
Fruit f = <Fruit name={CommonFruits.Banana} calories=105 />;
```

In the above code segment, a Fruit object is expecting a string, but an embedded expression is typed as enum CommonFruits. Thus, a method such as a ToString ( ) method may be used to convert the enum to a string literal value. If a ToString method exists that takes an IFonnatProvider, then this method can be employed to pass a culture invariant format into object Cultureonfo. InvariantCulture. Similarly, a calories attribute is typed as a string on the Fruit object, but is initialized with an integer literal, so an implicit culture invariant ToString ( ) can also be performed.

Validation rules can be described more precisely using formal notation. Thus, validation of an XML expression can be described utilizing the following relation: X validates as T˜˜>E, which states that an XML-expression X validates as type T if it can be proven by providing an expression E that contains no XML-expressions and that constructs an equivalent value of type T. The right hand side of the relation is called a “witness” or “proof” of the rule

Judgments make a statement about a given expression and it's relation to a language type, and a proof (or witness) is provided in the form of another expression. The types of relationships described by these judgments depend on the particulars of the expression. Inference rules express the logical relation between judgments and describe how complex judgments can be concluded from simpler premise judgments. A logical inference rule is written as a collection of premises and a conclusion, respectively written above and below a dividing line:

premise₁,

. . .

premiseₙ,

- - -

conclusion

All premises and the conclusion are judgments. The interpretation of an inference rule is: if all the premise judgments above the line hold, then the conclusion judgment below the line must also hold.

The following are examples of some formals rules emlployed by the validation system 350.

1. Deterministic:

(∀E1, E1:

X validates as T˜˜>E1

X validates as T˜˜>E2)=>E1.DeepEquals(E2)

where DeepEquals is comparing the entire object graph to make sure the instances are identical.

2. Members Outside of Sequence, Choice and all are Optional:

all {T1?; . . . Tn?} validates as class M {T1 n1; . . . Tn n;}

t1 validates as T1

t3 validates as T3

n1 is accessible

. . .

n is accessible

- - -

<M> t1 . . . tn</M> validates as class M {T1 n1; . . . Tn n; }

3. Top Level Element Names are Type Names:

t validates as M˜˜>t′

M <: N˜˜> f

- - -

<M>t</M> validates as N˜˜>f(t′)

4. Child Elements Can Use Field Names:

t validates as T˜˜>t′

- - -

<N>t</N> validates as sequencer{T N }˜˜> new sequence{N t′}

5. xsi:type Attribute:

S<: T

t validates as S˜˜>t′

using xsi=“http//www.w3.org/2001/XMLScheia-instance”

- - -

<N xsi:type=“S”>t</N> validates as sequencer{T N }˜˜> new sequence{N

=(T)t′}

6. Sequence Validation:

t1 validates as T1˜˜>t1′

t2 validates as T2˜˜>t2′

- - -

t1 t2 validates as sequence{T1,T2}˜˜> new sequencelt1′,t2′)

7. Subtyping:

T allows S˜˜> f

t validates as S˜˜>t′

- - -

t validates as T˜˜>f(t′)

Where allows is defined by the following inference rules:

S<: T

- - -

T allows S

This rule is powerful and is utilized to obtain all the core type system rules that are used during validation, like sequence and choice associativity, etc. However, the rule can be too powerful in practice. The rule would require that the validator search all subtypes of the expected type for a subtype that best matches the given content. Thus, this rule is constrained in practice with the additional requirement that the type must be defined by either the expected type in the content model, an xsi:type attribute or by the type of an embedded expression.

Sequence Deduction:

sequence{T} allows T

- - -

T allows S

Label Deduction:

sequence{T N} allows sequence{T}

- - -

T allows S

And Type Deduction:

class T {S}

- - -

T allows S

which is how we get the content of a labeled field: <start><x>O</x><y>O</y></start> to validate as class Point.

8. Type Coercion:

t parses as T˜˜>t′

- - -

t validates as T˜˜>t′

where “parses as” is defined as follows:

∃T Parse(string)t is string

- - -

t parses as T˜˜>Parse(t)

9. Embedded Expressions:

String typed expressions can be coerced using the same “parses as” rule defined above:

e parses as T˜˜> f

e is string

1- - -

{e} validates as T˜˜>f(e)

Then embedded expressions can also validate using the “allows” rule, also defined above:

S allows T˜˜>f

e<: S˜˜>e′

- - -

{e} validates as T˜˜>f(e′)

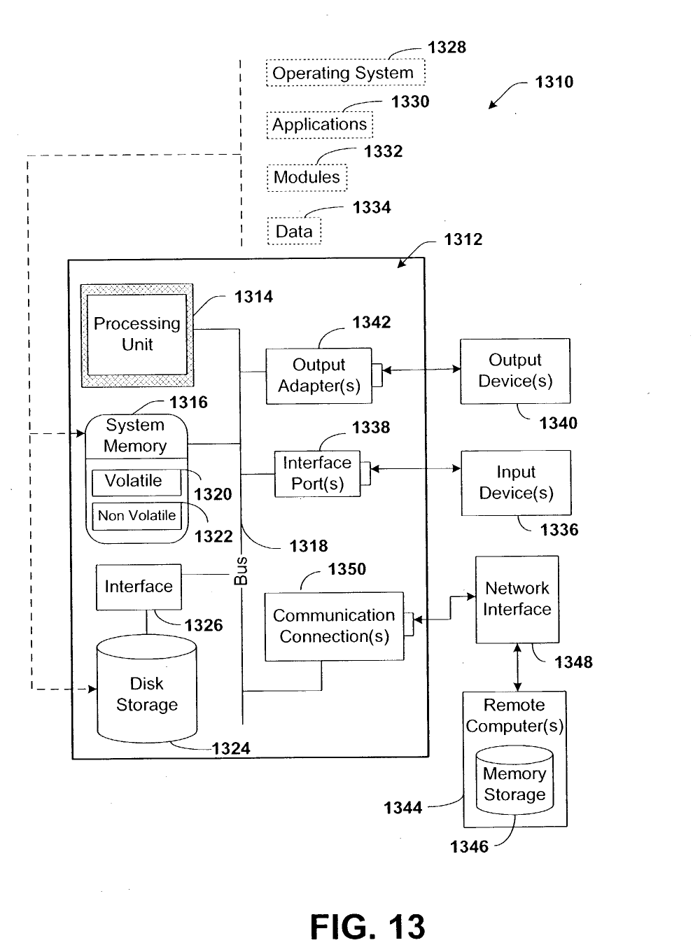

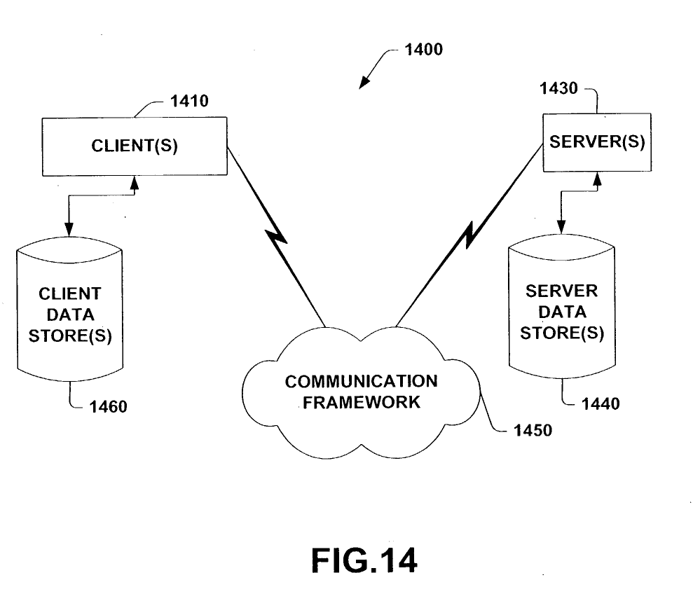

In order to provide a context for the various aspects of the invention, FIGS. 13 and 14 as well as the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practices on stand-alone computers. In a distributed computing environment, program modules may be locate in both local and remote memory storage devices.

With reference to FIG. 13, an exemplary environment 1310 for implementing various aspects of the invention includes a computer 1312. The computer 1312 includes a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable ROM (EEPROM), or flash memory. Volatile memory 1320 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1312 also includes removable/non-removable, volatile/non-volatile computer storage media. FIG. 13 illustrates, for example a disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to the system bus 1318, a removable or non-removable interface is typically used such as interface 1326.

It is to be appreciated that FIG. 13 describes software that acts as an intermediary between users and the basic computer resources described in suitable operating environment 1310. Such software includes an operating system 1328. Operating system 1328, which can be stored on disk storage 1324, acts to control and allocate resources of the computer system 1312. System applications 1330 take advantage of the management of resources by operating system 1328 through program modules 1332 and program data 1334 stored either in system memory 1316 or on disk storage 1324. It is to be appreciated that the present invention can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312, and to output information from computer 1312 to an output device 1340. Output adapter 1342 is provided to illustrate that there are some output devices 1340 like monitors, speakers, and printers, among other output devices 1340 that require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems and DSL modems, ISDN adapters, and Ethernet cards.

FIG. 14 is a schematic block diagram of a sample-computing environment 1400 with which the present invention can interact. The system 1400 includes one or more client(s) 1410. The client(s) 1410 can be hardware and/or software (e.g., threads, processes, computing devices). The system 1400 also includes one or more server(s) 1430. The server(s) 1430 can also be hardware and/or software (e.g., threads, processes, computing devices). The servers 1430 can house threads to perform transformations by employing the present invention, for example. One possible communication between a client 1410 and a server 1430 may be in the form of a data packet adapted to be transmitted between two or more computer processes. The system 1400 includes a communication framework 1450 that can be employed to facilitate communications between the client(s) 1410 and the server(s) 1430. The client(s) 1410 are operably connected to one or more client data store(s) 1460 that can be employed to store information local to the client(s) 1410. Similarly, the server(s) 1430 are operably connected to one or more server data store(s) 1440 that can be employed to store information local to the servers 1430.

What has been described above includes examples of the present invention. It is, of course, not possible to describe every conceivable combination of components or methodologies for purposes of describing the present invention, but one of ordinary skill in the art may recognize that many further combinations and permutations of the present invention arc possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An object literal creation system comprising:
an object creation component that constructs one or more object literals using tags; and
a validation component that checks the one or more object literals.

2. The system of claim 1, wherein the tags are defined by a user.

3. The system of claim 2, wherein the tags are extensible markup language (XML) tags.

4. The system of claim 2, wherein the tags contain attributes.

5. The system of claim 1, wherein the one or more object literals is untyped.

6. The system of claim 1 wherein the one or more object literals is strongly typed.

7. The system of claim 1, wherein the object creation component, during construction of at least one object literal, further constructs objects with expressions embedded within the tags.

8. The system of claim 7 wherein the embedded expressions are strongly typed.

9. The system of claim 7, wherein the embedded expression computes a value of an attribute.

10. The system of claim 1 further comprising a storage that stores the one or more object literals.

11. The system of claim 1, wherein the validation component validates constructed objects by employing inference rules that produce a witness.

12. A computer readable medium having stored thereon the components of claim 1.

13. The system of claim 1, wherein the tags contain embedded expressions.

14. An application programming interface comprising the system of claim 1.

15. A method of constructing object literals comprising:
surrounding an expression with complementary tags; and
computing a value of the expression dynamically at compile time.

16. A method of validating an XML expression comprising:
retrieving an XML expression;
normalizing the expression;
applying at least one inference rule to the normalized expression; and
determining whether a valid witness is produced.

17. The method of claim 16, wherein normalizing the expression comprises:
converting CDATA blocks to strings;
converting text content to string type with entities expanded; and
converting white space to string;

18. The method of claim 16, wherein the inference rule coerces a string to a type.

19. The method of claim 16, wherein the inference rule coerces a type to a string.

20. The method of claim 16, wherein the inference rule compares the compares the element name to the type name expression and produces and error if they are not the same.

21. An object literal creation system comprising:
means for constructing one or more object literals using tags; and
means for checking integrity of the one or more object literals.

22. A data packet that passes between at least two computer processes, comprising:
a first field that has stored therein computer executable instructions for constructing one of more object literals via employment of tags.

23. The data packet of claim 22, further comprising a second field that has stored therein computer executable instructions for validating integrity of the one or more object literals.

24. A system for validating an XML expression comprising:
means for retrieving an XML expression;
means for normalizing the expression;
means for applying at least one inference rule to the normalized expression; and
means for determining whether a valid witness is produced.
